(19) United States
(12) Patent Application Publication
(10) Pub. No.: US 2015/0061988 A1
(43) Pub. Date: Mar. 5, 2015

(54) Adaptive Power Savings on a Device Display

(71) Applicant: Texas Instruments Incorporated, Dallas, TX (US)

(72) Inventor: James Joseph Galu, JR., Richardson, TX (US)

(21) Appl. No.: 14/324,049

(22) Filed: Jul. 3, 2014

Related U.S. Application Data
(60) Provisional application No. 61/874,074, filed on Sep. 5, 2013.

(51) Int. Cl. G09G 3/34; G06F 3/0488; G09G 3/36

(52) U.S. Cl. CPC G09G 3/3406; G09G 3/3611; G06F 3/0488; G09G 2330/02
USPC 345/102; 345/87

(57) ABSTRACT

A device having a display screen may be operated in a partial view mode to reduce power dissipation. An application on the device may be performed while displaying results of the application on the entire display screen during a full view mode of operation. At some point while in full view mode, it may be determined that the results of the application may be displayed on a limited portion of the display screen. An unneeded portion of the display screen may then be turned off such that the results of the application are displayed only on the limited portion of the display screen while in a partial view mode of operation. When more information needs to be displayed, the device may return to full view mode.

### CLAIM OF PRIORITY UNDER 35 U.S.C. 119(E)

The present application claims priority to and incorporates by reference U.S. Provisional Application No. 61/874,074, (attorney docket TI-73969PS) filed Sep. 5, 2013, entitled “ADAPTIVE POWER SAVINGS ON LCD DISPLAY.”

### FIELD OF THE INVENTION

This invention generally relates to battery powered devices, and in particular to devices that use a lighted display.

### BACKGROUND OF THE INVENTION

Battery powered devices such as calculators and smartphones often have an active display that is used to provide information to a user. Many such devices use a liquid crystal display (LCD). An LCD is an electronically modulated optical device made up of any number of pixel locations filled with liquid crystals and arrayed in front of a light source (backlight) or reflector to produce images in color or monochrome.

Many types of battery powered devices use backlit LCD screens, which tend to use a significant portion of the battery energy. In order to conserve energy, the back light may be dimmed, but this may make it more difficult to read the display.

### SUMMARY

A device having a display screen may be operated in a partial view mode to reduce power dissipation. An application on the device may be performed while displaying results of the application on the entire display screen during a full view mode of operation. At some point while in full view mode, it may be determined that the results of the application may be displayed on a limited portion of the display screen. An unneeded portion of the display screen may then be turned off such that the results of the application are displayed only on the limited portion of the display screen while in a partial view mode of operation. When more information needs to be displayed, the device may return to full view mode.

### BRIEF DESCRIPTION OF THE DRAWINGS

Particular embodiments in accordance with the invention will now be described, by way of example only, and with reference to the accompanying drawings:

FIG. 1 is a screen shot of an example electronic device that includes an LCD screen, illustrating power consumption by the screen while in full power mode;

FIGS. 2A, 2B, and 3 illustrate example LCD screens in which a portion of the screen may be cloaked to reduce power consumption during a partial view mode;

FIG. 4 is a schematic illustrating operation of a prior art backlight for an LCD screen;

FIG. 5 is a schematic of an LCD backlight that allows operation of a portion of the LCD in a reduced power mode;

FIG. 6 is a schematic of an plasma display screen that allows operation of a portion of the screen in a reduced power mode;

FIG. 7 is a schematic of an deformable micro-mirror device screen that allows operation of a portion of the screen in a reduced power mode;

FIG. 8 is a block diagram of a self powered device; and

FIG. 9 is a flow diagram illustrating operation of a self powered device.

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency.

The backlight on a battery powered mobile device with a large color LCD may consume a significant amount of power from the battery. In many devices, the backlight component of the display module has the highest impact on the battery life.

On many mobiles devices, such as calculators and Smartphones for example, a user often only needs to interact with 25% or less of the LCD Screen to perform simple and common tasks such as basic 1-line math calculations on a graphing calculator, or placing phone calls or reading a text message on a smart phone, for example. Therefore, 75% or more of the LCD and its power consuming backlight may be turned off until needed by the user. Embodiments of the invention may determine when only a portion of the screen is needed for an application and then turn off the rest of the screen. The full screen may be turned on in response to user input or in response to an application that requires the full screen.

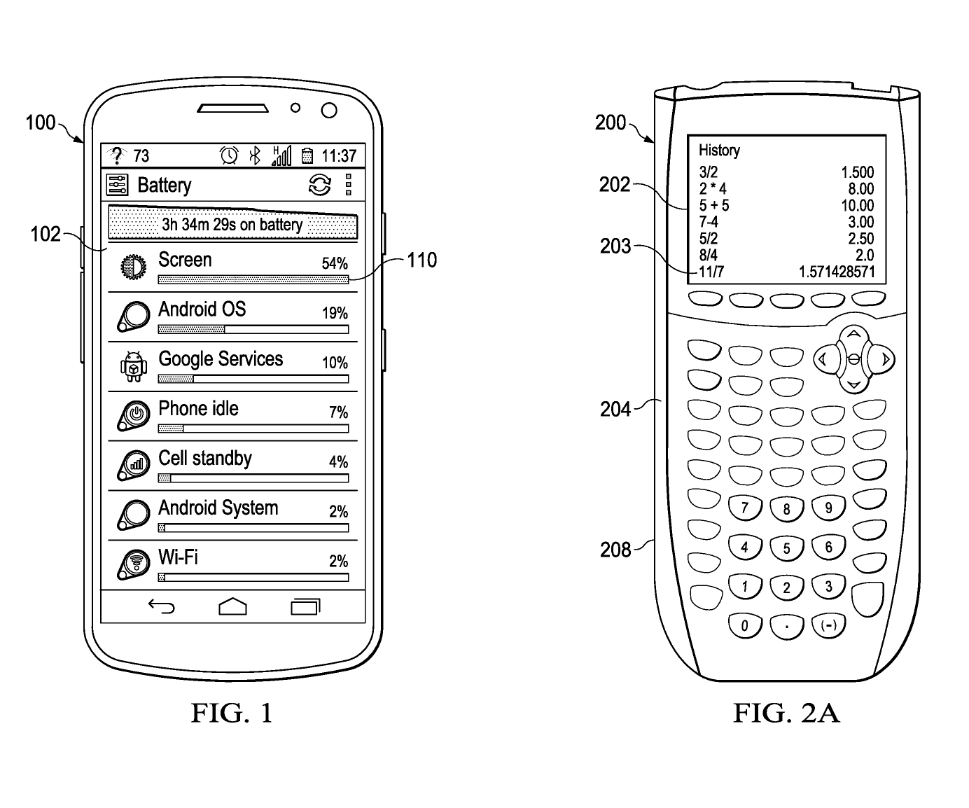

FIG. 1 is a screen shot of an example electronic device 100 that includes an LCD screen 102, illustrating power consumption by the screen while in full power mode. In this example, the device is an Android based smart phone. A battery use meter application on the smart phone keeps track of how much power is being used by each portion of the device and provides the information as illustrated in FIG. 1. In this example, the device has been operating on battery power for three hours and thirty four minutes. During that period, the screen used approximately 54% of the power that was used by the device during that period of time as indicated at 110 on the screen.

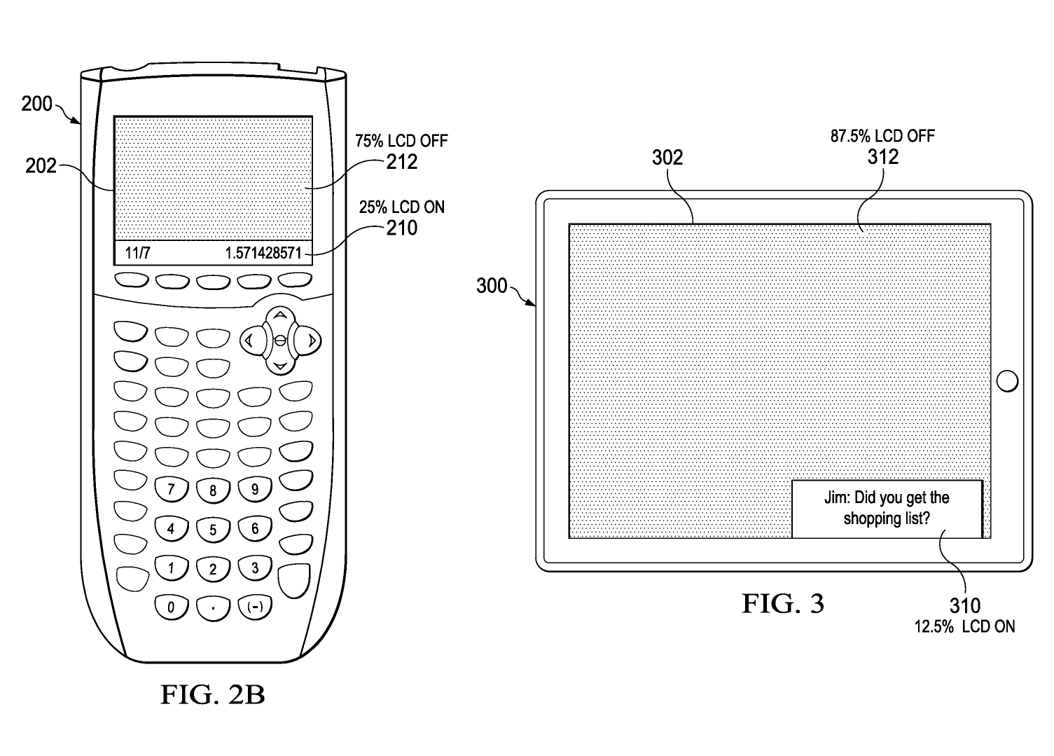

FIGS. 2A, 2B, and 3 illustrate example LCD screens in which a portion of the screen may be cloaked to reduce power consumption during a partial view mode. Embodiments of the invention may greatly improve battery life by segmenting the screen backlight into halves, quarters, eighth's or higher, into tiles, into rows, or into columns so that only a portion of the display that the user is focused on may be made visible during a partial view mode while the rest of the display is darkened and thereby cloaked from view. When the user wants to see a larger portion of the screen, then additional segments may be activated such that up to 100% of the display may be turned on by returning to full view mode.

The operation of an LCD is well known and need not be described in detail herein; see for example: “Liquid-Crystal Display,” Wikipedia, last updated 9 Jun. 2014, which is incorporated by reference herein. In brief, an LCD is an electronically modulated optical device made up of any number of pixel locations filled with liquid crystals and arrayed in front of a light source (backlight) or reflector to produce images in color or monochrome. Each pixel typically consists of a layer of molecules aligned between two transparent electrodes, and two polarizing filters (parallel and perpendicular). Without the liquid crystal between the polarizing filters, light passing through the first filter would be blocked by the second (crossed) polarizer. In a commonly used twisted nematic device, the surface alignment directions at the two electrodes are perpendicular to each other, and so the molecules arrange themselves in a helical structure, or twist. This induces the rotation of the polarization of the incident light, and the device appears light, or transparent, with no voltage applied to the electrodes. If the applied voltage is large enough, the liquid crystal molecules in the center of the layer are almost completely untwisted and the polarization of the incident light is not rotated as it passes through the liquid crystal layer. This light will then be mainly polarized perpendicular to the second filter, and thus be blocked and the pixel will appear black. By controlling the voltage applied across the liquid crystal layer in each pixel, light can be allowed to pass through in varying amounts thus constituting different levels of gray.

FIG. 2A illustrates a calculator device 200 in which the screen 202 is being operated in full view mode. In this example, a sequence of calculations has been performed and the history is being shown. The latest calculation is shown on the bottom line at 203.

For illustrative purposes, embodiments may be described herein with reference to the TI-84 Plus C Silver Edition calculator device. Other embodiments may include the TI-Nspire CX™ handheld graphing calculators and the TI-Nspire CX™ software available from Texas Instruments, for example. One of ordinary skill in the art will appreciate that embodiments are not limited to these examples.

Handheld calculators with more or fewer components may be used in embodiments of the invention. As shown in FIG. 2A, the handheld calculator 200 includes a graphical display 202, and a keypad 204. The graphical display 202 may be used to display, among other things, information input to applications executing on the handheld calculator 200 and various outputs of the applications. The graphical display 202 may be, for example, an LCD display. The keypad 204 allows a user, e.g., a student or instructor, to enter data and functions and to start and interact with applications executing on the handheld calculator 200. The keypad 204 also includes an alphabetic keyboard for entering text. Calculator 200 is enclosed within a housing 208 that also contains a battery that provides power to operate calculator 200.

FIG. 2B illustrates calculator device 200 operating with 75% of the screen turned off, as indicated at 212 while in partial view mode. 25% of the screen is active and displays the latest calculation step, as shown at 210. As will be explained in more detail below, a portion of the backlight light emitting diodes (LEDs) are turned off in the darkened portion 212. In order to provide a clean look and eliminate bleed through from the active backlight LEDs, the LCD crystals in screen portion 212 are flipped to maximum opacity (BLACK) to prevent light bleeding into the area where LEDs are turned off. In this manner, a portion of the screen is cloaked and power consumption is reduced while in a partial view mode.

If the user hits a button that requires the full screen, such as: Menu, Graph, Apps, etc., for example, the Calculator may power 100% of the LCD and Backlight LEDs and resume full view mode.

FIG. 3 illustrates a smartphone 300 in which only 12.5% of its LCD screen 302 and backlight are turned on to allow the user to view a message notification while in a partial view mode to save power, as indicated at 310. The remaining ⅞s of the LCD is cloaked to reduce power consumption. If the user presses a designated button or one of a set of buttons to call for a full screen, then the phone may power 100% of the LCD and Backlight LEDs and resume full view mode. Similarly, a user may perform a screen gesture on a touch sensitive screen to resume full view mode, such as an upward swipe, for example.

In various embodiments, a different percentage of the screen may be cloaked, ranging from just a small percentage to almost the entire screen in some cases. In various embodiments, various locations on the screen may be treated as the active area and the cloaked area.

Screen 302 is touch sensitive and allows a user to interact with the display screen by translating the motion and position of the user's fingers on the touch sensitive screen 302 to provide functionality similar to using an external pointing device, e.g., a mouse. A user may use the touch screen to perform operations similar to using a pointing device on a computer system, e.g., scrolling the display 302 content, pointer positioning, selecting, highlighting, etc. The touch screen capability may remain enabled and responsive to touch input even while a portion of the screen is turned off. This allows a user to enter gestures on top of a black screen, for example.

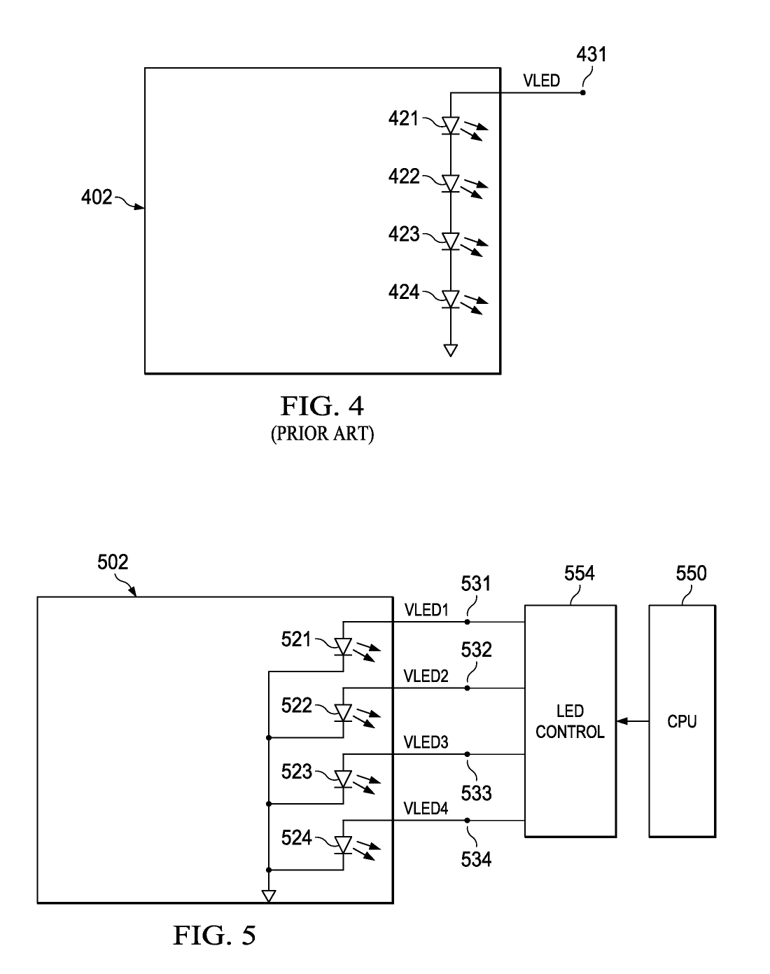

FIG. 4 is a schematic illustrating operation of a prior art backlight for an LCD screen 402. In this example, four light emitting diodes (LEDs) 421-424 are connected in series and powered by a single supply point 431. Alternatively, the LEDs may be connected in parallel. Typically, current limiting resistors will also be included to control current flow through the LEDs. In some cases, the value of the resistor(s) may be changed to dim or brighten the display by allowing more or less current to flow through the LEDs.

FIG. 5 is a schematic of an improved LCD backlight for and LCD screen 502 that allows operation of the LCD screen in a partial view mode to reduce power dissipation and thereby extend battery life. In this example there are four backlight LEDs 521-524. Each one has a separate power connection 531-534 that allows each LED to be independently turned on and off. Power control logic 554 may be configured to provide power to each LED 521-524 in response to commands from central processing unit 550, for example, as will be explained in more detail below.

While four LEDs are depicted here, embodiments may have various numbers of LEDS that may be arranged various manners, such as: in a simple row or column, or in an array to provide back light for quadrants or even smaller portions of a display screen, for example. In some embodiment, each LED may be a single white LED for a grey scale display, for example. In other embodiments, there may be colored LEDs, such as red, blue, green, for use in a color display screen, for example. In either case, the LED control circuit may be configured to allow a portion of the screen backlight to be turned off in order to operate in a partial view mode.

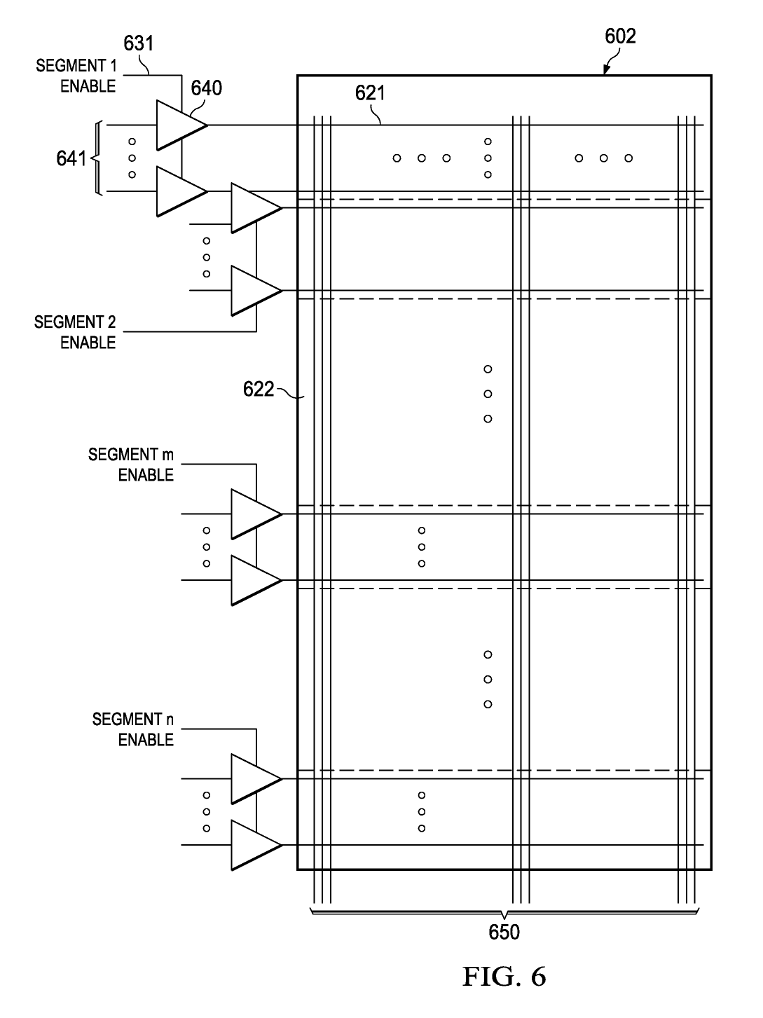

FIG. 6 is a schematic of an improved plasma display screen 602 that allows operation of a portion of the screen in a partial view mode to provide reduced power consumption. The general operation of a plasma screen is well known and need not be described in detail herein; see for example: “Plasma Display,” Wikipedia, last updated 6 Jun. 2014, which is incorporated by reference herein. In brief, a plasma panel typically comprises millions of tiny cells in between two panels of glass. These compartments, or “bulbs” or “cells”, hold a mixture of noble gases and a minuscule amount of another gas (e.g., mercury vapor). Just as in the fluorescent lamps over an office desk, when the mercury is vaporized at a temperature of over 1200° C. and a high voltage is applied across the cell, the gas in the cells form a plasma. With flow of electricity (electrons), some of the electrons strike mercury particles as the electrons move through the plasma, momentarily increasing the energy level of the atom until the excess energy is shed. Mercury sheds the energy as ultraviolet (UV) photons. The UV photons then strike phosphor that is painted on the inside of the cell. When the UV photon strikes a phosphor molecule, it momentarily raises the energy level of an outer orbit electron in the phosphor molecule, moving the electron from a stable to an unstable state; the electron then sheds the excess energy as a photon at a lower energy level than UV light; the lower energy photons are mostly in the infrared range but about 40% are in the visible light range. Thus the input energy is shed as mostly heat (infrared) but also as visible light. Depending on the phosphors used, different colors of visible light can be achieved. Each pixel in a plasma display is made up of three cells comprising the primary colors of visible light. Varying the high voltage of the signals to the cells thus allows different perceived colors.

Long electrodes of electrically conducting material lie between the glass plates, in front of and behind the cells, such as the horizontal electrodes indicated at 612 and the vertical electrodes indicated at 622. The “address electrodes” may sit behind the cells, along the rear glass plate, and may be opaque. The transparent display electrodes may be mounted in front of the cell, along the front glass plate. Control circuitry charges the electrodes that cross paths at a cell, creating a voltage difference between front and back.

In this example, the horizontal electrode drivers 641 may be organized as segment groups, such as segment group 641, for example. Each segment may have an enable signal, such as segment 1 enable 631, for example, that may control the drivers in the associated segment group. In this manner, by controlling the enable signals, an application program may easily turn off portions of plasma screen 602 while operating in a partial view mode. In this example, horizontal segments may be turned off while operating in partial view mode. Other embodiments may arrange for vertical segments to be turned off. Other embodiments may implements a more complex electrode/driver design and have controllable segments that are configured differently.

Alternatively, an application may modify the contents of a screen buffer that may be used to provide a display image to screen 602. The application may over-write the screen buffer to force a portion of the screen to appear black, in which case that portion of the screen is not active and does not dissipate power. In this manner, an application may cause any portion of the screen to be darkened to save power. The darkened portions may be of any shape.

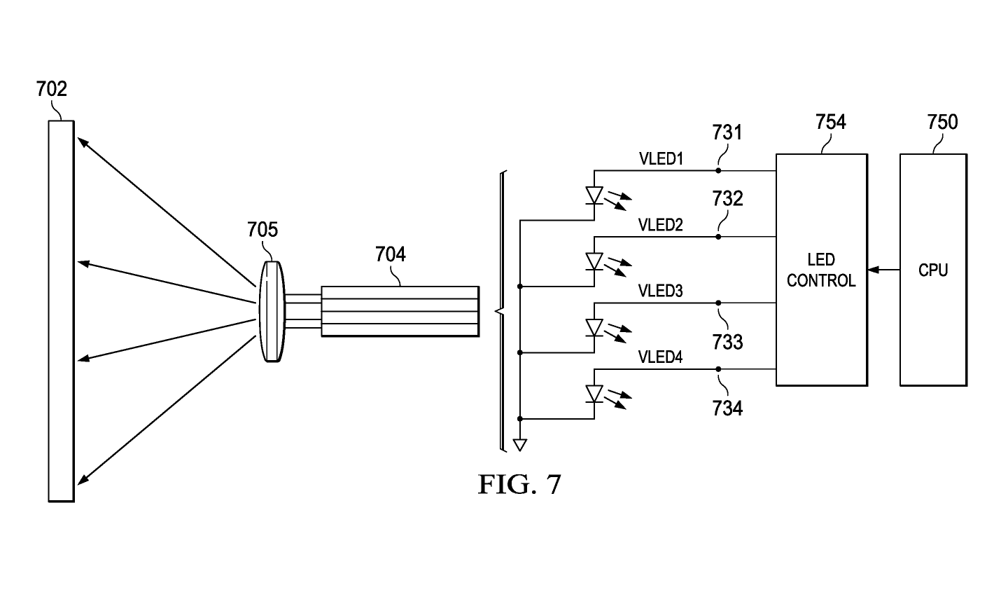

FIG. 7 is a schematic of an improved deformable micro-mirror device (DMD) screen 702 that allows operation of the DMD screen in a partial view mode to reduce power dissipation and thereby extend battery life. The general operation of a DMD screen is well known and need not be described in detail herein; see for example: “How DLP Technology Works,” Texas Instruments, 2013, which is incorporated by reference herein. In brief, a DLP (digital light processing) chip is perhaps the world's most sophisticated light switch. It may contain an array of 8 million or more hinge-mounted microscopic mirrors; each of these micro-mirrors measures less than one-fifth the width of a human hair. When a DLP chip is coordinated with a digital video or graphic signal, a light source, and a projection lens, its mirrors can reflect a digital image onto any surface. A DLP chip's micro-mirrors tilt either toward the light source in a DLP projection system (ON) or away from it (OFF). This creates a light or dark pixel on the projection surface.

Light from a light source may be passed through a collimator 704 and then through a lens 705 and then directed to a front surface of DMD 702. The reflected light may then be projected for viewing on a screen in some embodiments. In other embodiments, the DMD may be viewed directly, such as in a headset that may be worn by a user, for example.

In this example there are four source-light LEDs 721-724. Each one has a separate power connection 731-734 that allows each LED to be independently turned on and off. Power control logic 754 may be configured to provide power to each LED 721-724 in response to commands from central processing unit 750, for example, as will be explained in more detail below.

While four LEDs are depicted here, embodiments may have various numbers of LEDS that may be arranged various manners in conjunction with collimator 704, such as: in a simple row or column, or in an array to provide source-light for quadrants or even smaller portions of a display screen, for example. In some embodiment, each LED may be a single white LED for a grey scale display, for example. In other embodiments, there may be colored LEDs, such as red, blue, green, for use in a color display screen, for example. In either case, the LED control circuit may be configured to allow a portion of the screen source-light to be turned off in order to operate in a partial view mode.

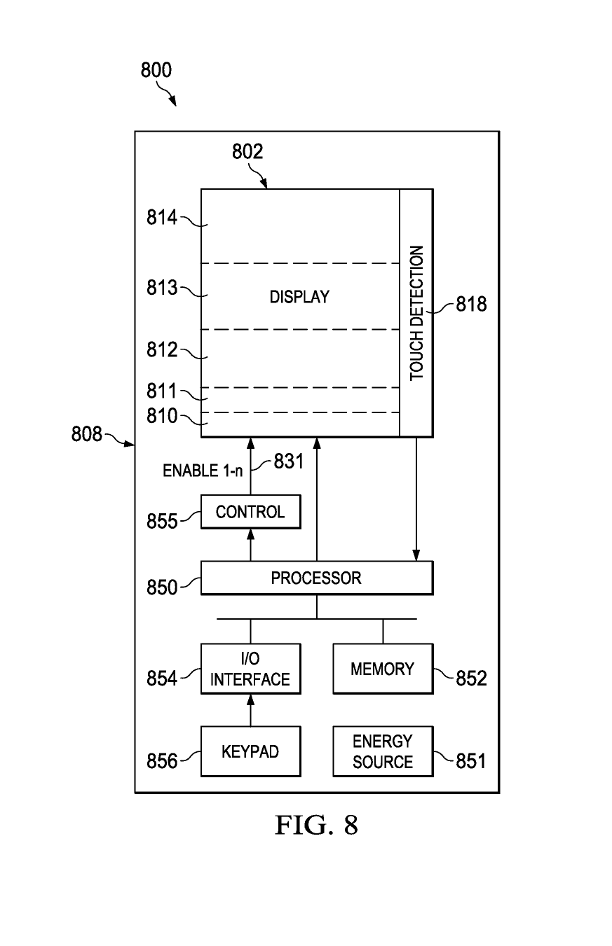

FIG. 8 is a block diagram of a self powered device 800 that includes a lighted display screen 802. Display screen 802 may be representative of any of the screens 202, 302, 502, 602, or 702 described above, for example. Processing logic 850 and energy source 851 is packaged within housing 808. The term “processing logic” as used herein refers to all, or at least most, of the circuitry that provides the functionality of device 800. Energy source 851 may be a battery, for example. Alternatively, or in combination, self powered device 800 may include another type of energy source, such as: a solar cell, a super capacitor, various types of energy harvesting systems, etc., for example.

In this example, the processing logic includes a microprocessor 850 that is coupled to a memory 852 that may include one or both of read-only memory (ROM) and random-access memory (RAM). In some embodiments, the ROM stores software programs implementing functionality described herein and the RAM stores intermediate data and operating results, for example. In some embodiments, a portion of the memory may be non-volatile, such as a flash memory or FRAM (Ferroelectric read only memory), for example. I/O interface logic 854 is coupled to processor 850 and provides an interface to keypad 856. Control logic 855 may include one or more outputs that may be controlled by a program executed by processor 850 to generate control signals, such as control signal enable 1-n 831, which as was described above in more detail. Display 802 is coupled to and controlled by processor 850. The general operation of electronic devices such as device 800, which in this case may be a hand held calculator or a smart phone for example, is well known and need not be described in further detail herein.

In this example, display screen 802 is divided into a number of segments 810-814. The segments may be the same size, or they may be of different sizes as illustrated here, for example. As described above, they may be oriented horizontally, vertically, or be in the shape of quadrants, or other shapes and sizes, for example.

Processor 850 may execute instructions that are stored in memory 852 to implement various applications, as is well known. One or more of the applications may be modified or have a wrapper added that causes it to instruct control logic 855 to turn off a portion of the display screen segments when the application does not need the entire display screen to provide results to a user of device 800. As discussed above, an application such as text messaging may only need to display one or a view lines of a text message, therefore a significant portion of the screen may be turned off. Similarly, a calculator application may only need to display the last one or two entries and a significant portion of the screen may be turned off to conserve power.

At some point, a user may wish to see more than a limited portion of the screen. The user may press a designated button on keypad 856 that may then be interpreted by an application being executed by processor 850 as a request to return to full view mode. In response, processor 850 may then send a command to control logic 855 to enable all segments of display 802.

Alternatively, a user may input a gesture using a touch sensing feature of display 802. In this case, a designated gesture may be detected by touch logic 818 using known gesture detection processing that may be performed by processor 850 or by another processor coupled to touch detection logic 818, for example. A simple gesture such as an upward swipe may be used to request return to full view mode, for example.

Alternately, an accelerometer or other type motion detection device (not shown) within device 800 may be used to detect motion of device 800. In this case, a designated inertial event may be detected by the motion detection device using known motion detection processing that may be performed by processor 850 or by another processor coupled to the motion sensor, for example. A simple inertial event such as a vertical or a horizontal jerk of device 800 may be used to request return to full view mode, for example.

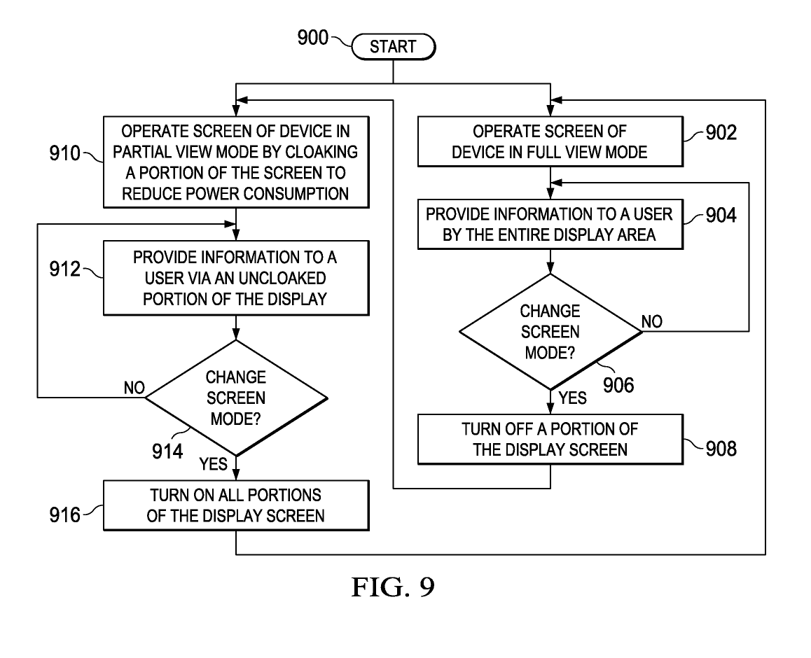

FIG. 9 is a flow diagram illustrating operation of a self powered device having an illuminated display screen, as described in more detail above. A discussed above, the device may be a calculator, a smart phone, or any one of a wide variety if fixed or mobile devices in which reducing power dissipation is beneficial. The display screen may be similar to any of the screens 202, 302, 502, 602, or 702 described above, for example. Initially, when the device is turned on 900, it may be configured to operate in either a full view mode 902 or in a reduced power partial view mode 910. The choice of initial screen view mode may be determined by a profile setting for a user preference, for example.

When the device is operating in full view mode 902, the entire screen is activated and power consumption by the screen is maximized. Information may be provided 904 to a user by using the entire display area. As with prior art devices, a user may configure the device to reduce the power consumption by reducing the brightness of the screen. However, even with the screen brightness reduced, significant power may be dissipated by the display screen while in full view mode.

However, many applications do not need to use the entire screen to interact with a user. As discussed above, an application such as text messaging may only need to display one or a view lines of a text message, therefore a significant portion of the screen may be turned off. Similarly, a calculator application may only need to display the last one or two entries and a significant portion of the screen may therefore be turned off to conserve power. Thus, when an application determines 906 that it does not need the entire screen, it may request that the device be put in a lower power partial view mode. A portion of the screen may be turned off 908 to conserve power, as described in more detail above.

While operating in partial view mode, a portion of the screen may be cloaked 910. As discussed above, power consumption by an LCD display may be reduced by turning off one or more of the back light LEDs. However, just turning off the back light LEDs may create a transition area on the screen that may be unattractive. In this case, the LCD pixels in a portion of the screen may be set to appear black, thus blocking out any stray backlight from the portion of the screen that is not being used. Setting the pixels to black in a portion of the screen is referred to “cloaking” herein. Cloaking may be performed by overwriting the screen buffer that holds an image of the screen. The image data that is overwritten may be saved so that it may be restored when the device returns to full view mode, for example.

Similarly, in a plasma type display, a portion of the screen may be cloaked 910 by overwriting the screen buffer that holds an image of the screen. The image data that is overwritten may be saved so that it may be restored when the device returns to full view mode, for example. In the case of a plasma display, this alone will reduce screen power consumption because the pixel cells in the cloaked portion of the screen will not be activated, since they are set to be black. Alternatively, segments of a plasma screen may be turned off using signals to disable a portion of the electrode drivers, as discussed above with respect to FIG. 6, for example.

Similarly in a DMD type display, a portion of the source lights may be turned off to conserve power and a portion of the display may then be cloaked by overwriting the screen buffer that holds an image of the screen in order to set the mirrors to a dark position, thus blocking any stray source light. The image data that is overwritten may be saved so that it may be restored when the device returns to full view mode, for example.

While in partial view mode, an application may provide information to a user 912 via an uncloaked portion of the screen.

In some embodiments, the display screen may be touch sensitive. While in partial view mode, the touch sensitive capability may remain enabled so that a user may enter gestures over the darkened portion of the screen, for example.

At some point, the application may determine 914 that more of the screen is needed for interaction with a user. The entire screen may be turned on 916 to return to full view mode 902. Alternately, less than the entire screen may be turned on if the entire screen is not needed. In this case, the device may operate in a partial view mode 910 in which a larger portion of the screen is used 912 to provide information to a user.

Alternatively, the user may decide that he or she would like to view more of the screen. In this case, the user may indicate 914 that the screen mode should be changed. As discussed in more detail above, the user may hit a button that requires the full screen, such as: Menu, Graph, Apps, etc., for example, for a calculator application.

Alternatively, the user may input a gesture using a touch sensing feature of the device, as described above in more detail. A simple gesture such as an upward swipe may be used to request 914 return to full view mode, for example. Alternatively, a simple inertial event such as a vertical or a horizontal jerk of the device may be used to request 914 return to full view mode, for example.

The battery may last significantly longer on devices which embody this power saving scheme. Implementation of the power saving scheme described herein is simple and may require only a few I/O ports to toggle power or an LCD module may have this simple logic built in, for example.

### Other Embodiments

While the invention has been described with reference to illustrative embodiments, this description is not intended to be construed in a limiting sense. Various other embodiments of the invention will be apparent to persons skilled in the art upon reference to this description. For example, other embodiments may include various desktop, mobile or personal battery powered electronic devices, such as: tablets, digital reading devices, mobile phones, desktop computers, portable computers, cameras, etc., for example.

While batteries were discussed herein, embodiments of the invention may be used for self powered devices with other types of energy sources, such as: a solar cell, a super capacitor, various types of energy harvesting systems, etc., for example.

Additionally the cloaked screen features discussed, while created for the purpose of power savings, may also be used for other purposes such as utility, entertainment such as games, and other interactive software, for example.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A self powered device, comprising:
an energy source positioned within a housing of the device;
processing logic configured to perform functions of the device;
a display screen coupled to the processing logic and the energy source;
an illumination source coupled to the display screen; and
control logic responsive to the processing logic coupled to the illumination source, wherein the control logic is configured to disable a portion of the illumination source during a partial view mode such that only a portion of the display screen is illuminated and to enable all of the illumination source during a full view mode such that all of the screen is illuminated.

2. The self powered device of claim 1, wherein the display screen is an LCD screen and the illumination source is a multi-lamp backlight.

3. The self powered device of claim 1, wherein the display screen is a plasma screen and the illumination source is the pixels of the screen.

4. The self powered device of claim 1, wherein the display screen is a deformable mirror device, and the illumination source a collimated multi-lamp source.

5. A method for operating a device having a display screen, the method comprising:
performing an application on the device while displaying results of the application on the entire display screen during a full view mode of operation;
determining while in full view mode that the results of the application may be displayed on a limited portion of the display screen; and
turning off an unneeded portion of the display screen such that the results of the application are displayed only on the limited portion of the display screen while in a partial view mode of operation.

6. The method of claim 5, further comprising:
determining while in partial view mode that the results of the application should be displayed on the entire display screen; and
turning on the entire display screen to return to full view mode such that the results of the application are displayed on the entire display screen.

7. The method of 6, wherein receiving a designated key input from a user of the device determines that the results of the application should be displayed on the entire display screen.

8. The method of 6, wherein detecting a particular gesture from a user of the device determines that the results of the application should be displayed on the entire display screen.

9. The method of 8, wherein the gesture is a swipe on a touch sensitive screen.

10. The method of 8, wherein the gesture is tap on a touch sensitive screen.

11. The method of 8, wherein the gesture is an inertial event.

12. The method of claim 5, wherein the display screen is a backlit LCD having a plurality of light sources, wherein turning off the unneeded portion of the display screen comprises turning off a portion of the plurality of light sources; and
further comprising setting each pixel in the unneeded portion of the display screen to be opaque.

13. The method of claim 5, wherein the display screen is a plasma screen having a plurality of luminous pixel cells, wherein turning off the unneeded portion of the display screen comprises disabling a portion of the plurality of luminous pixel cells.

14. The method of claim 5, wherein the display screen is a deformable mirror device with a plurality of mirror pixels and having a multiple lamp collimated light source, wherein turning off the unneeded portion of the display screen comprises turning off a portion of the multiple light sources; and
further comprising setting each mirror of the plurality of mirror pixels in the unneeded portion of the display screen to be dark.

15. The method of claim 5, wherein the display screen is touch sensitive, further comprising detecting gestures on the touch sensitive screen while the screen is in partial view mode.
